(19) United States
(12) Patent Application Publication
(10) Pub. No.: US 2016/0034709 A1
(43) Pub. Date: Feb. 4, 2016

(54) METHODS AND APPARATUS FOR MULTIGENERATIONAL FAMILY STORAGE VAULT

(71) Applicant: GENERAL VAULT, LLC, Jacksonville, FL (US)

(72) Inventors: Jeffrey Englehardt, Jacksonville, FL (US); William D. Meadow, Jacksonville, FL (US)

(21) Appl. No.: 14/816,049

(22) Filed: Aug. 2, 2015

Related U.S. Application Data
(60) Provisional application No. 62/032,540, filed on Aug. 2, 2014.

(51) Int. Cl. G06F 21/62

(52) U.S. Cl. CPC G06F 21/6245

(57) ABSTRACT

The present invention relates to apparatus and methods for receiving one or both of documents and artifacts that may include mages, medical records and other information (Family Docs) from Family Members and storing the information and heirlooms in an organized and secure manner according to Family Member Profiles.

### CROSS-REFERENCE TO RELATED APPLICATION

This application claims priority to and the full benefit of U.S. Provisional Patent Application Ser. No. 62/032,540, filed Aug. 2, 2014, and titled “METHODS AND APPARATUS FOR MULTIGENERATIONAL FAMILY STORAGE VAULT”, the entire contents of which are incorporated herein by reference.

### BACKGROUND OF THE INVENTION

This invention relates to methods and apparatus for convenient storage and retrieval of Family Related Records. The methods and apparatus use a distributed network to provide storage and retrieval of Family Documents that may be generally Family Member generation and location agnostic.

Currently, it is commonplace families to keep important paper documents, electronic records, photos, heirlooms and other important items to the family in a safe place where over a period of years, they often become misplaced, damaged, electronically inaccessible or forgotten. Generally, a parent or grandparent is entrusted with and deeply wants to maintain such records, and few are adequately skilled to organize and store the increasingly large set of diverse electronic and paper documents from various sources as well as various family heirlooms. As a result, many paper documents and other electronic records are misplaced, difficult to locate and access electronically.

As Family Members grow more mobile and live in multiple disparate locations in the course of a lifetime, the issue of maintaining family records is exacerbated. For example, until the last two generations, Family Members generally lived in or around a single county for multiple generations. A physical location for storing important documents would be known by Family Members and accessible within a short travel distance to access. The amount of relevant documents was relatively small and did not require much organization,

Today, with the Internet available to nearly every person on earth, there are numerous email and cloud file management systems that enable individual users to store emails, attachments and files of any type on-line. In addition, the user may make available any set of folders and files to friends, relatives, colleagues and vendors. However, the rules by which they enable the sharing is not established automatically.

End user consumer applications provide very simple procedures for naming and utilizing “Defined Folders” to store documents and email attachments are well known.

End user consumer applications provide very simple procedures for creating “User Groups” with email systems and document access systems are well known.

Rules for “Provisioning Users” with various network access rights are well phone. In many cases a flat file with names, numbers, access rights and other fields of data can be imported as a flat CSV file to generate large numbers of accounts automatically.

Today, Family Members are spread across multiple cities and time zones, and often in different countries. Understanding where family related documents are located and how they are organized and accessed has become very difficult to manage. In addition, the number and diversity of electronic document formats and digital image formats necessary for Family Members to track has increased significantly in the Internet Age. Health records, legal documents, identification documents, as well as commercial documents, such as deeds, licenses, mortgage documents, warranties, receipts as well as social media data and various forms of communication must all be available in today's world, but no single vehicle is available to make such information available in a convenient, accessible and secure fashion for all Family Members over time.

What is needed is an apparatus that will conveniently receiver, organize, provision, secure, and archive Family Docs and heirlooms by importing and then making paper and electronic records available from a variety of government, commercial, personal and Internet based sources on a worldwide basis that meets the needs of families desire to conveniently provision and maintain long term complete access of their personal and private electronic records and heirlooms in formats and structures that can automatically support the various technology changes of industries as well as families go through as children are raised, move out and get married and navigate many life events pleasant and un pleasant while maintaining the comfort in knowing that the apparatus will be there carrying out its duties for generations to come.

### SUMMARY

Accordingly, the present invention provides apparatus and methods for receiving governmental and commercial documentation, digital camera images and videos, medical records and other paper and electronic information (Family Docs) from Family Members and storing the information in an organized and secure manner according to a family structure. The Family Docs are then made available via a distributed digital network, such as the Internet to those organized as Family Members.

Family Docs will be stored digitally and made available via any device that is capable of accessing a website and also capable of providing a secure transaction. In some preferred embodiments, Family Docs will be placed in Family Storage by organized Family Members. In other embodiments, Family Docs may be sent to Family Storage by a third party. Documents provided by a third party may be pre-assigned to a particular file location according to the party that sent it, or allocated to a review area for staging and filing. For example, a third party may be a utility company submitting a monthly invoice, or a vendor submitting a receipt for a purchase. The utility company invoice may be pre-assigned to a file location and the vendor receipt may be placed in a review area for proper allocation or destruction.

The invention enables the automatic creation of privileges based on Family Relationships (which vary according to Cultural Mores, Biological Heritage, and Government Agency Sanctioned Rights) which can be supplemented with individual HOH user preferences.

The invention enables Government Agency Surrogates and Health Care Workers to quickly and easily access and translate critical Family Docs information regarding essential family members. In some embodiments, a government representative or designee, such as a court appointed advocate, an agency member, a case worker, a hospice worker, a charity worker or other person acting on behalf of, or for a Family member may also be granted rights into a Family Vault on behalf of the Family Member.

According to one aspect of the present invention, a family will “own” all Family Docs related information and as such, the Family Docs information will be secure from access by unauthorized parties. As such, Family Docs allow for control of access by unwanted third parties.

In another aspect, access to family docs may be made available from any location in the world connected to the Internet. Access to the internet becomes more universal throughout the world as technology becomes more and more widespread. Wireless and cellular connection to the internet also increases the locations from which Family Docs may be accessed. Digital storage of Family Docs also allows for physical redundancy on multiple continents and backups such that even in the event of a natural disaster or act of war, so long as the Internet is operational, the Family Docs should be accessible.

The present invention also provides for ease of physical backups and generation of multiple physical copies if desired. Organization of Family Docs may be easily manipulated online, such as, by way of non-limiting example: birth certificates in a specified file designation, health records in specified file and database designations, and other valuable asset documents such as household and motor vehicle information in a specified file designation. Physical records may be printed and/or accumulated and stored in a physical file structure that emulates the online storage structure. In this manner, a Family Storage Vault may act as an electronic catalogue or file index of a physical file storage. The Family Storage Vault may retain scanned copies of originals that are stored in a hard cop file cabinet containing physical files.

In another aspect of the present invention, a “Family” may include any hierarchical or relational association with a physical address at a time of residence. Accordingly, a “Family” may include blood relations, such as one or more generations of parents-children; a business with a defined reporting hierarchy; and a peer relationship, such as members of a club or organization. In some preferred embodiments, each Family Member is associated on some level via a physical street address. For example, parents may live at an address of the family home, and sibling children will be associated with the parents address whether or not the children currently reside at the parent's physical address.

Embodiments may also include authorization levels or privileges that are granted according to a role in designated “Family”. For example, a Mother and Father may be acknowledged as Head of Household (HOH) and granted authorizations according to their role as respective heads of the family or Spawned Family Units. Children may be granted more limited access or full access according to the wishes of the family and the children grow into adults.

In still another aspect, access may be granted to trusted third parties, such as accountants and lawyers. Each trusted third party may be granted access to those records appropriate to the role that they play for the family. A HOH may set the appropriate rights of access to the folders and files.

In another aspect, a submission to a Family Vault via email may be automatically routed to a security level and designated storage folder based upon an email address of the sender.

Embodiments include a computer server to implement the above methods via executable software stored on the server. If desired, the executable software may be executed on demand via the network access device over a communications network. A network access device will typically be an electronic device such as a computer or a wireless computing device, which may include one or more of wireless, mobile and cellular linked tablets, smart phones and flat panel digital or projection display devices. Devices may conform to the transmission control protocol/internet protocol, cellular protocol or other communication protocol.

Additionally the present invention may include a WEB interface for accessing the executable software stored on the server storage medium, or a method of interacting with a graphical user interface so as to facilitate a financial investment utilizing the above methodologies.

Still other embodiments include computer executable program code residing on a computer-readable medium or a computer data signal embodied in a digital data stream.

The details of one or more embodiments of the invention are set forth in the accompanying drawings and the description below. Implementations may provide advantages such as supplemented funding for students attending a learning institution or supplemented funding of principals involved in a business venture. Other features, objects, and advantages of the invention will be apparent from the description, the drawings and the claims.

### DESCRIPTION OF THE DRAWINGS

FIG. 1 illustrate block components that may be utilized to implement some embodiments of the Family Document System.

FIG. 2 illustrates a detailed diagram with exemplary entities that may be involved in some implementations of the present invention.

FIG. 3 illustrates basic components of an apparatus that may be used in some embodiments of the present invention.

FIG. 4 illustrates additional aspects of apparatus that may be used in some implementations of the present invention.

FIG. 5 illustrates a user interface with functionality that may be included in the present invention.

FIG. 6 illustrates a block diagram embodiments of the present invention that include storage of physical Family Heirlooms.

FIG. 7 illustrates how a Family member may provision various familial relationships via an automated Family Relationship Profiles Device system.

FIG. 8 illustrated a block diagram of some aspects of the present disclosure that allow for a parent to create a family member relationship.

FIG. 9 illustrates a Venn type diagram with Family Bubbles to represent various familial relationships.

FIG. 10 illustrates a block diagram of a network access device that includes a mobile device and may be used in some implementations of the present invention.

### DETAILED DESCRIPTION

The present invention provides methods and apparatus for defining a relationship between “family” members and providing a secure storage vault for mutual access of stored data based upon the defined relationship. A communications network may be used to receive and retrieve data from any location the communications network may be accessed with a network access device. Stored data may include data that is accessible to one or more Family Members.

### GLOSSARY

“Auto Load” as used herein means automatically storing data in a predetermined storage designation based upon a security quality of a submitter of the data and a type of data i.e. attachment or data stream.

“Access Color” a visual color indicator associated with a submission or email based upon a security designation.

“Bits” as used herein means any information or artifact that may be stored as electronic or digital data. Examples of Bits may include, but is not limited to: emails, files, database entries, scanned physical records, images, replicable objects such as cell cultures, digital representation of biologics such as blood sample or biopsies, audio files, video files, and image files. [ADDITIONAL EXAMPLES MAYBE INCLUDED IN THE SPECIFICATION]

“Biosample” as used herein shall mean one or more of data and images descriptive of a biological aspect of a Family Member and in some embodiments may include a location of a physical specimen.

“Blending” as used herein means association of an attachment to an email (or other submission to an account) to multiple vault accounts based upon the inclusion of multiple email addresses (or other unique identifiers) with the submission.

“Data Formats” as used herein means . . . . “Define A Family Unit” as used herein means the act of creating a Family Unit Unique Identifier

“Defined Folders” as used herein means . . . .

“Designated Folder” a storage designation, such as a file directory, where data is automatically stored based upon rules associated with a Family Storage Vault.

“Extended Family” as used herein means the act of a HOH of a Family Unit establishing a Next of Kin Link. As described and illustrated in Figure . . . .

“Family Related Records” as used herein means . . . .

“Family Preference Profiles” as used herein means a set of Family Storage Vault configurations that Family Unit Head of Household selects to determine a variety of roles, access rights, privileges and Family Doc and Heirloom management parameters.

“Family Base Account” as used herein means an account that is automatically generated when a new individual account is formed and associated with a first defined Family Member of a new uniquely defined family. In some examples, the account is permanent and ownership and access may be transferred to other Family Members, such as children and siblings or “shirt tail relatives” if no other closer related person is identified or willing to assume the responsibility.

“Family Docs” as used herein means paper documents (text and/or image), scanned versions of paper documents, electronic records in any format that are the property of one or more Family Members, issued by a government entity in regard to a Family Member or are descriptive of a Family Member.

“Family Heirlooms” as used herein shall mean a physical document or artifact that a Family member designates to be retained for transfer to another Family Member. In some embodiments the transfer may be to a generation of Family member different than the Family member designating the document or artifact as an heirloom.

“Family Members” as used herein means two or more persons that associate themselves as a Family Unit.

“Family Member Surrogate” as used herein means a person authorized to act on behalf of a Family Member. In some examples of the present invention, a Family Member Surrogate may be contingent upon a set of conditions that must be met, such as, a capacity and/or availability of the Family Member.

“Family Relationship Configurations” as used herein mean a vehicle to indicate rights allocated to Family Members to access, duplicate and eliminate contents of a Family Vault.

“Family Storage Vault” as used herein means a digital storage medium in logical communication with a communications network capable of transmitting digital data to and from the digital storage medium, wherein the digital storage medium receives, stores and accesses and transmits stored digital data based upon defined relationships between two or more Family Members, such as those defined by Family Unit Preference Profiles.

“Family Unit” as used herein means a user defined set of more than one individual, in some examples of the present invention, a Family Unit may be defined based upon one or more of: an official government sanctioned and certified marriage relationship, cohabitation of a shared residence, a declared engagement, a domestic partner, a civil union, a common law marriage spouse, a legal guardianship or other government designation, a government designated head of Household, a facility administrator where one or more persons are under care of an unrelated designee or any other self declared designation between individuals that reflects the nature of their relationship as family.

“Family Unit, Next of Kin” as used herein means a HOH defined an individual user as a member of the Extended Family.

“First Family Member” as used herein means a person that created an associated Family Vault Account”

“Granted Authorization” as used herein shall mean an authorization implemented by a Head of Household conveying rights by use of their authenticated online credentials (i.e. password, biometric or other identifier) to other Family Members or their Proxies to allow access to one or more aspects of a Family Vault.

“Government Defined Relationship” as used herein means the definition of a Family Relationship that a citizen of a legal jurisdiction acknowledges for individuals that are governed by such jurisdiction.

“Head of Household” as used herein means one or more persons designated to manage other Family Member accounts as well as the Family Account.

“Heirloom” as used herein means any physical object that is owned by Family Member and is intended to be kept safe to enable one passing of possession from one Family Member to another. This can include “BioSamples”.

“Spawned Bits” as used herein means the act of replicating contents of a Family Vault for a Family Member, such as a Child, Relative or a Proxy who in turn becomes a HOH, thereby creating the Child as the HOH of a new Family Unit access to and control of copies of contents of a Family Vault.

“Spawned Family Unit” as used herein means a new Family Vault Account created Child, Relative or a Proxy of an existing Family Vault.

“Trusted Third Parties” as used herein shall mean a person or entity that one or more Family Members or Proxy has designated as authorized to access at lest some portion of a Family Vault for a specified purpose, examples include, but are not limited to: an entity providing healthcare services, an educational institution, or government agency)

“Provisioning Users” as used herein means the acts taken initially by a First Family Member who is creating a Family Unit. The act includes creating a set of authenticating credentials to designate a Second Family Member with a name and other identifying information such as date of birth and various government issued identification numbers. The act may include creating additional Family Members by providing identifying information and user preferences for access via an on-line application.

“Unique Identifier” as used herein means the method by which a Family is defined by the initial Head of Household.

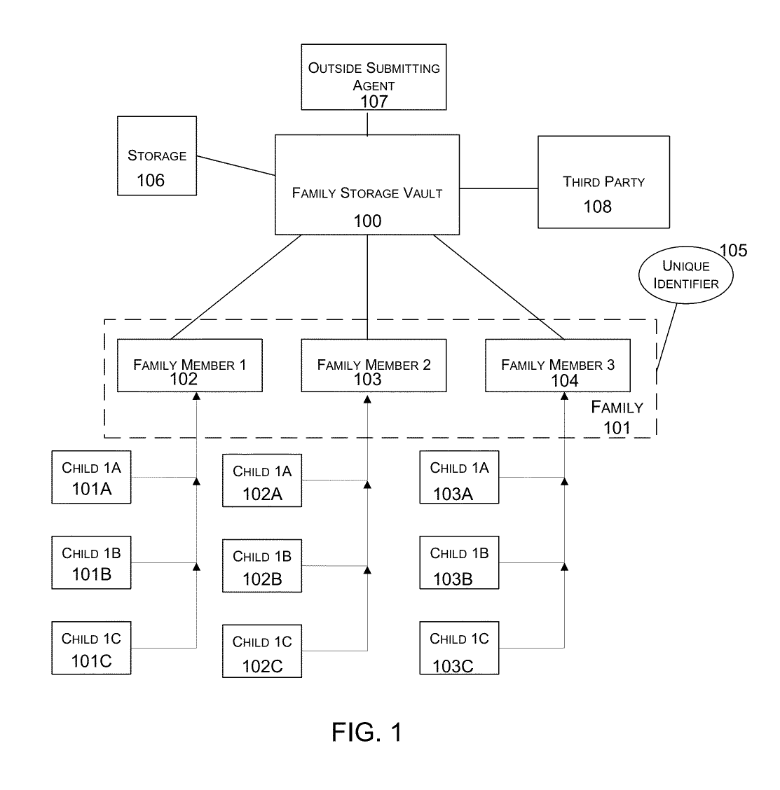

Referring now to FIG. 1, a block diagram illustrates various components that may be used to implement embodiments of the present invention. As defined further below, a Family Storage Vault 100 includes a digital storage medium 106 accessible via a communications network. The Family Storage Vault 100 is controlled via an automated processor, in logical communication with, or incorporated into the Family Storage Vault 10 that receives and stores data associated with a Family 101 with at least two Family Members 102-104. The Family Storage Vault 100 includes a defined relationship between two or more Family Members 102-104. The defined relationship is referenced to provide access to disparate portions of information stored in the Family Storage Vault 100.

In some embodiments, a Family 101 is associated with a Unique Identifier 105, the Unique Identifier may include almost any manner of uniquely identifying the Family 101. Specific examples of Unique Identifiers may include a Family location in combination with, or otherwise associated with; a time period (such as, for example, a street address or town during specified years and months); a Family patriarch or matriarch identifying number, such as a Social Security Number, a military ID number, an employee number or other number; a telephone number and time period; a universally unique identifier (“UUID”) generated by the Family Storage Vault 100; or other data to identify a Family with certainty in relation to other Families.

A Family may include two or more Family Members 102-104 and/or one or more Children 101A-C to 103A-C with a defined relationship indicating how two or more Family Members 102-104 and/or Children 101A-C to 103A-C relate to each other. Relationship may include, by way of non-limiting example: a biological parent child relationship; a legal parent child relationship; a biological sibling relationship; a legal sibling relationship; any parent child multi-generational relationship; a biological extended family relationship, including aunts, uncle sand cousins; a legal extended family relationship, including aunts, uncles and cousins; a domestic partnership; extended family relationship with a nexus in a domestic partnership; a common law marriage relationship; a legal guardianship; or other defined hierarchical and legal or biological relationship.

A Family Storage Vault 100 may receive data provided by one or more Family Members 102-104 by way of digital transmission over the communication network or by scanning physical documents submitted to the Family Storage Vault 100. The Family Storage Vault 100 may also receive data to be stored via an Outside Submitting Agent 107 who acts on behalf of a Family Member. The Outside Submitting Agent 107 may include, for example: an attorney, an accountant, a government agent, a proxy, a medical professional business partner or administrator or other professional, engaged by or otherwise acting on behalf of or at the request of a Family Member. The Family Storage Vault 100 may thereby allocate rights at the request of one or more Family members that are not within the scope of traditional security enablements, but are specifically allocated according to the needs or request of a Family Member.

In another aspect, a Family Storage Vault 100 may receive data from a third party 108 with only a minor relationship to the Family Member. A Third Party 108, may include, for example: a vendor submitting a receipt; an employer; an educational institution; HOA; or other entity that has been supplied with a destination addressable via the communications network. A destination may include, for example: an Internet Protocol address, an email address, a uniform resource locater (“URL”), a fax number, a telephone number, or other electronic destination.

In some specific embodiments, documents may be submitted for storage via a hard copy postal address or street address, wherein the postal address is associated with a particular Family Storage Vault 100 and following delivery of the time to be stored, a digital image memorializing the document is crated and stored in the Family Storage Vault 100.

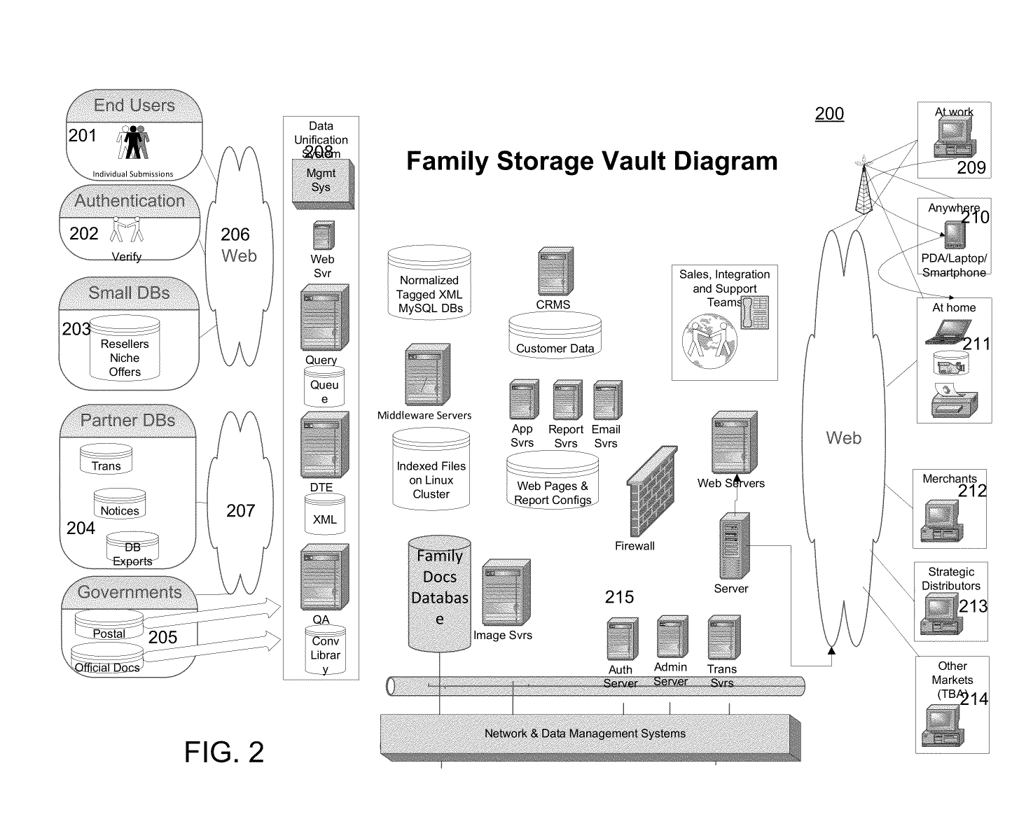

Referring now to FIG. 2, a network illustrates some implementations of the present invention. As illustrated, a Family Storage Vault 100 system 200 may include databases, and computer servers to interface with the outside world via one or more servers. The Family Storage Vault 100 system 200 may be protected by firewalls and include image files, databases and data files. The Family Storage Vault 100 system 200 may connect to external entities 201-205 209-214 via one or more communication networks, such as the Internet, the World Wide Web, virtual private networks, cellular networks, telephonic networks or other communication network capable of transmitting and receiving digital information.

In one aspect, a user 201 may directly transmit data to the Family Storage Vault 200 for proper archiving and storage and retrieval. In another aspect, a server, such as a quality assurance server 202 may provide authentication services and certify the authenticity of a data submission to the Family Storage Vault 200. Authentication may include for example, a government certification that an official document is a certified document. For example, a copy of a birth certificate, a passport, a driver's license, a tax return, a patent or other government or quasi-government document. Similarly, an authentication server 215 may be associated with a non-governmental entity, such as a bank, a medical office, an insurance company, a work of art producer or expert, or other non-official office. For example, an insurance office may issue an authenticated copy of an insurance policy, a medical office may authenticate medical records, and a producer of works of art, or an art appraiser may certify that a piece of art is what it is represented to be. Other embodiments of a document image associated with a registered authorization and a link may accompany delivery of a document to a Family Storage Vault.

In another aspect, small database generators of documents to be archived in a Family Storage Vault 200 may include resellers or niche offers. In today's world, a user may be bombarded with an almost constant stream of advertisements, special offers, updates, alerts and other electronic communications. According to one aspect of the present invention, such communications may be received and stored by a Family Storage Vault 200 and accessed by one or more Family Members or other users.

Similarly, partner database servers 204 may supply to a Family Storage Vault 200, larger amounts of data that may be received by the Family Storage Vault 200 and stored in appropriate electronic receptacles. Partner database servers may include contracted services, social media, organizations with which a Family member is associated, of other beneficial service.

At 205, government related servers 205 may also provide information to a Family Storage Vault 200. The government server 205 may transmit official documentation, or generalized information. The Family Storage Vault 200 may receive and organize the information provided by the government server and store it for access by one or more Family Members. By way of non-limiting example, a Family member may receive government information related to Social Security into the Family Storage Vault 200. The Family Storage Vault 200 will store the government information in a secure storage allocated to such documents. A Child of the Family Member may also be granted access to the Family Storage Vault 200 storage for the Family Member based upon the Child's relationship with the Family Member. In some embodiments an Authentication Server 202 may also provide a certification or other authentication of the Social Security documents.

Delivery of documents to the Family Storage Vault 200 may be accomplished via a communications network 206-207 capable of transmitting digital data, or via a telephone network, data line, cellular network or other electronic communications medium. Specific embodiment may include a mobile network access device 210 capable of communicating via a cellular network or via IP Protocol.

By way of non-limiting example, various embodiments may include communication with a Family Storage Vault 200 originating from a network access device including a workstation at a place of employment 209. A user may access as a Family Member or as a third party submitting a document to a storage associated with a Family Member. A Family Member or third party may also access via a mobile network, such as a cellular or WiFi network from any location serviceable via the network. Similarly, a Family Member or Third Party may access Family Storage Vault 200 from a home location 211 and conduct one or more of: manage a family account; supply documents to be stored; provide access permissions for other Family Members, add nee Family Members and retrieve stored documents.

Outside commercial interests that may also provide documentation and/or receive data from the Family Storage Vault 200 may include merchants 212, strategic partners 213 and partners engaged on a limited basis 214.

In some embodiments, a first partner, such as a bank or other financial institution may provide an authenticated payment device, such as a number, a hash, an alphanumeric value, or an image to a Family Storage Vault 200 and a vendor may be provided access to the payment device in order to consummate payment or other transaction. In some preferred embodiments, the payment device may be updated on a regular basis in order to minimize any instances of fraud.

Provisioning Family Members the system will provide for the Defined Folders to be automatically created with the ability configure individual preferences.

The provisioning process will create the appropriate demarcation of records to establish privacy options for children as they become adults on their 18^{th} birthday (or such age as local customs and government agencies authorize). The grant or denial of access is based on “Family Relationship Configurations”.

The creation of a Family Unit, Next of Kin involves establishing a set of credentials to facilitate designation of a Family Relationship, examples may include a First Name, Last name and email address. An additional step, includes defining Next of Kin who will be part of an Extended Family and who will be granted automatic rights and access as established by the HOH for his “Family Access Profiles”.

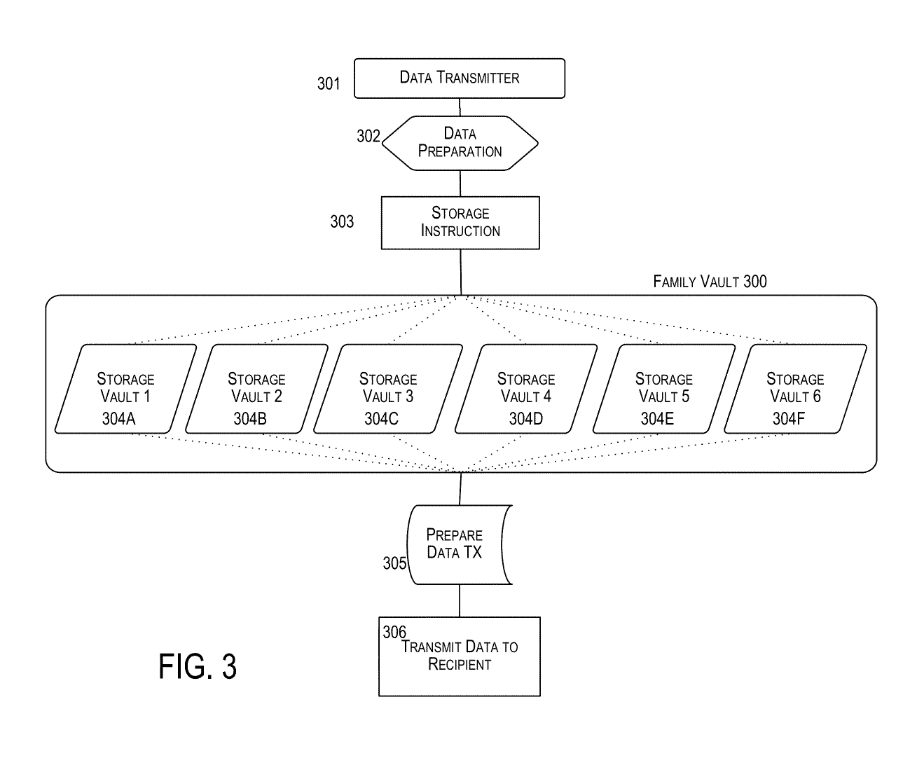

Referring now to FIG. 3, a block diagram illustrates entities and actions involved in some implementations of the present invention. A Data transmitter 301 may prepare data to be transmitted 302 and also provide a storage instruction. The storage instruction may include, for example, one or more of: a selected storage vault 304A-F to place prepared data into; which Family Members including which Children are granted permissions to stored data and the extent of the permissions; any third parties that may have access to the stored data; how long the stored data should be stored, and any special request for the stored data.

A Family Storage Vault 100 300 may also be operative to prepare data for transmission 305 to a Family Member or a designate of the Family member. Preparation may be in response to a specific request or instruction received via the communications network. For example, Family member may transmit an instruction to access a particular storage medium in a Family Storage Vault and obtain one or more specified documents or other stored artifacts and package the specified documents and artifacts into a transmission to be delivered to a specific address for receipt by the designated recipient. The Family Storage Vault may also be operative to transmit specified documents and artifacts to a specified recipient 306. Preparation of data packages may include compressed, or zipped files, encryption, password protection or other preparation of a virtual “package” of data. Preparation of data for transmission 305 and transmission of data 306 may be in response of a user request for data, or according to preprogrammed instructions to periodically transmit data or to transmit data based upon one or more conditions being met.

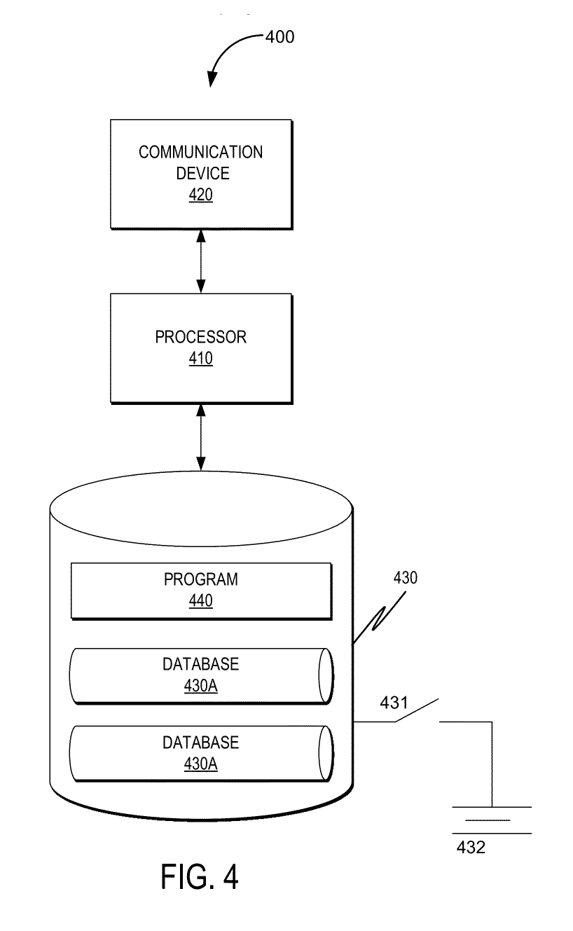

Referring now to FIG. 4, an illustration is provided with a controller 400 that may be embodied in one or more communications accessible devices and utilized to implement some embodiments of the present disclosure. Communications accessible devices may include, by way of example, a hand held device such as a cellular phone, a pad device, a personal computer, a computer server, a tablet device, an electronic reader device or other programmable digital device. The controller may be activated via a user activated switch 431 wherein activation may be equated with closing the switch and completing an electrical circuit to connect power to a device in the system. A device that is connected to the electrical power may include, for example, one or both of: a server and a network access device. A power source 432 may include a power supply with a transformer that receives in AC current and provides DC current at a suitable voltage and current to power the device wo which it is connected. Activating a switch may also cause software to execute and control the controller to accomplish a predefined series of method steps.

The controller 400 comprises a processor unit 410, which may include one or more processors, coupled to a communication device 420 configured to communicate via a communication network, such as the Internet, or a cellular based network such as a 3G or 4G network (not shown in FIG. 4).

The processor 410 is also in communication with a storage device 430. The storage device 430 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 430 can store a program 440 for controlling the processor 410. The processor 410 performs instructions of the program 440, and thereby operates in accordance with the present disclosure. The processor 410 may also cause the communication device 420 to transmit information, including, in some instances, control commands to operate apparatus to implement the processes described above. The storage device 430 can additionally store related data in a database 430A and database 430B, as needed.

As described herein, the present disclosure includes automated apparatus and methods for providing a receptacle for Family related documents and information controlling access to the stored information. In some embodiments, the apparatus and methods utilize metadata to control and manage information contained in the various databases. As used herein metadata generally includes a relatively smaller amount of data applies mainly to electronically archived or presented data and may be used in relation to the a) definition, b) structure and c) administration of data files with contents in context to facilitate the use of the captured and archived data for further use. In the present disclosure, metadata may be used to control or describe which data is viewable, to which users and administrators, for what period of time and other controlling or limiting factors.

Metadata may be created and managed for each entry included in a Family Vault database. In some embodiments, a Family Vault server may add metadata tags to data that is accessed by Family Members so that a data origination source may be determined and a data recipient may be determined. In some embodiments, the Family Vault server may create and maintain an audit trail of usage based on metadata links and make such audit trail available to an authorized Family Member, Surrogate, or other user.

Metadata may be expressed in grammatical terms; that is with a descriptive structure. Noun objects may be gateway addresses that are available and accessible, data elements that are sharable, or data for which access is forbidden. Verb actions may describe how these noun objects are processed; that is how they are operated upon. Finally adjective and adverb objects may be used to refine what is shared and how it is shared including security control. In different embodiments, the metadata sentence structure might contain gateway names, IP addresses, ownership rights, granted permission types, data specifications (type, content, source, etc.), expiration dates or other descriptive information that describes the data to which the metadata is applied.

In some embodiments, communication over a communications network may be secured via encryption. As used herein, a secure communication may include an encryption algorithm to achieve a secure transmission over the communications network. Methods such as SSL and TSL may be used form transmissions to and from a Family Vault. In some embodiments, additional security may be implemented via hardware encryption and recognition software. An example is the security protocols available as part of the Internet Protocol Version 6 IPv6 standard. Using the features of the IPv6 standard, or the like, one can ensure that the hardware at the designated IP address is known and trusted for secure communication. Using what is referred to as tunneling mode, the hardware component of the communication may implement security features that include an electronic handshake verification process and an additional hardware layer of encryption of the communicated information.

In some specific examples, One-Time-Pad (OTP) may be used to implement security features. Physical communication devices, such as routers, may use hardware level security handshakes, data encryption using features in the IPv6 standard and OTP security to ensure levels of security for the packets transferred over the Internet or other communications network. In such examples, two or more copies of a random set of characters or numbers are created. The encryption includes an addition to each character in a message with a character in the OTP. This scheme may implement an OTP that is as long as, or longer than the data to be encrypted. The decryption may perform a subtraction of a pad character with the received data. This scheme may provide speed advantages with electronic OTP with binary data. In such examples an encryption scheme may include simple logical XOR, and the decryption may include a simple XOR with the receiver's copy of the OTP, whereby data may be encrypted and decrypted at speeds in excess of a data transmission speed. Some embodiments may include a virtual OTP system wherein pads may be generated as requested.

Reference OTP and reference key settings may be (1) supplied externally with a pair of memory chips (e.g. solid state drive memory) or (2) generated randomly using a complex algorithm running on the primary router. If generated randomly using a complex algorithm running on the primary router, the seed may be a text string typed in by the administrator of the primary router, or by a hardware function in the router. Once two routers are registered, they may independently update random OTP transformation pad and algorithm settings by recording output from a broadcaster at predetermined time periods.

Communication may be implemented via an initiator router and a responder router pair which have been registered with each other. The initiator router ay transform a reference OTP and create a handshake OTP using input from a broadcaster and settings for an algorithm. It then sends a handshake request to the responder router at its prerecorded IP address set during the routers' earlier mutual registration. The handshake includes an OTP encrypted random character string in the hardware IPv6 header. The responder router uses its information to form its handshake OTP which should be identical to the one generated by the initiator router based upon identical information from their mutual registration with each other. The responder router's handshake may be formed by decrypting a received random character string, and re-encrypting it using a next set of OTP contents. The initiator router verifies that the response is received from the proper IP address, and then decrypts the handshake and compares it to the original character string.

A successful handshake may occur wherein a shared OTP for the given IP address is validated and a next a session key may be created that is a different OTP from the one used to do the authentication handshake.

A primary and a second router handshake and then establish a primary session key. The primary router establishes a valid handshake connection to third router as requested by the second router. The master router then using the handshake encoding, transmits the primary session key to the third router. A second and third router may communicate the required data using the primary session key.

As described further herein, the steps discussed in this disclosure may be implemented in digital electronic circuitry, or in computer hardware, firmware, software executing on a computer, or in combinations of them. The techniques may be implemented as a executable code, such as, for example, a computer program tangibly embodied in tangible, machine-readable storage medium, for execution by, or to control the operation of, data processing apparatus. A data processing apparatus may include a programmable processor, a computer, a server, a smart device, a tablet, a cellular phone device or multiple programmable devices.

A computer program may be written in a suitable form of programming language for the corresponding device, including, for example, compiled or interpreted languages. The computer program may be deployed in a suitable form for a corresponding device, including, for example, as a stand-alone program or as a module, component, subroutine, or other unit suitable for use in a computing environment. A computer program may be deployed to be executed on one computer or on multiple computers at one site or distributed across multiple sites and interconnected by a communication network.

Method steps discussed herein and the techniques described herein may be performed by one or more programmable processors executing a computer program to perform functions described herein by operating on input data and generating output. Method steps can also be performed by, and apparatus of the invention may be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. A computer, smart device, cellular phone, tablet or other programmable device may include a processor for executing instructions and one or more memory devices for storing instructions and data.

For the purposes of this disclosure the term “server” may be understood to refer to a service point which can provide processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

A programmable device may also include, or be operatively coupled to receive data from or transfer data to, or both, one or more mass storage devices for storing data. Storage media suitable for embodying computer program instructions and data include all forms of non-volatile memory, including by way of example semiconductor memory devices, EPROM, EEPROM, and flash memory devices; magnetic disks, internal hard disks or removable disks; magneto-optical disks; and CD-ROM and DVD-ROM disks. The processor and the memory may be supplemented by, or incorporated in special purpose logic circuitry.

In some embodiments, automated apparatus for implementing various aspects of the invention may also include clients and servers. A client and server are generally remote from each other and typically interact over a communication network. The relationship of client and server arises by virtue of computer programs running on the respective computers and having a client-server relationship to each other.

Automated apparatus described in the embodiments herein should not be limited to the disclosed embodiments, but rather should be limited only by the spirit and scope of the following claims.

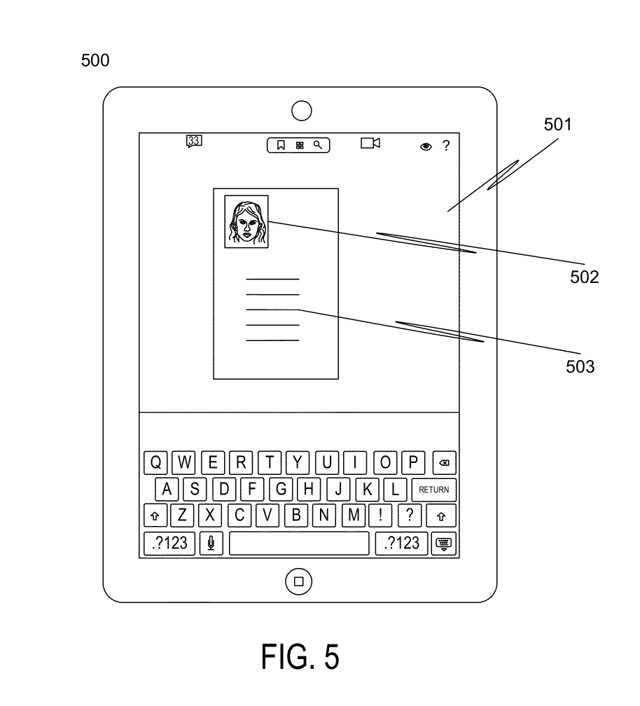

Referring now to FIG. 5, a user interface 501 may be presented on a human readable display 500. The user interface includes one or both of human readable graphics 502 and text 503 which represent data included in the operation of a Family Vault. The interface may be operable on a tablet device, a mobile phone device, a personal computer or any other user interactive device supporting a graphical user interface. In some embodiments the display may be customized based upon a Family member logged into the display.

The interface 501 may include interactive areas for controlling the functionality described herein in relation to an automated Family Vault.

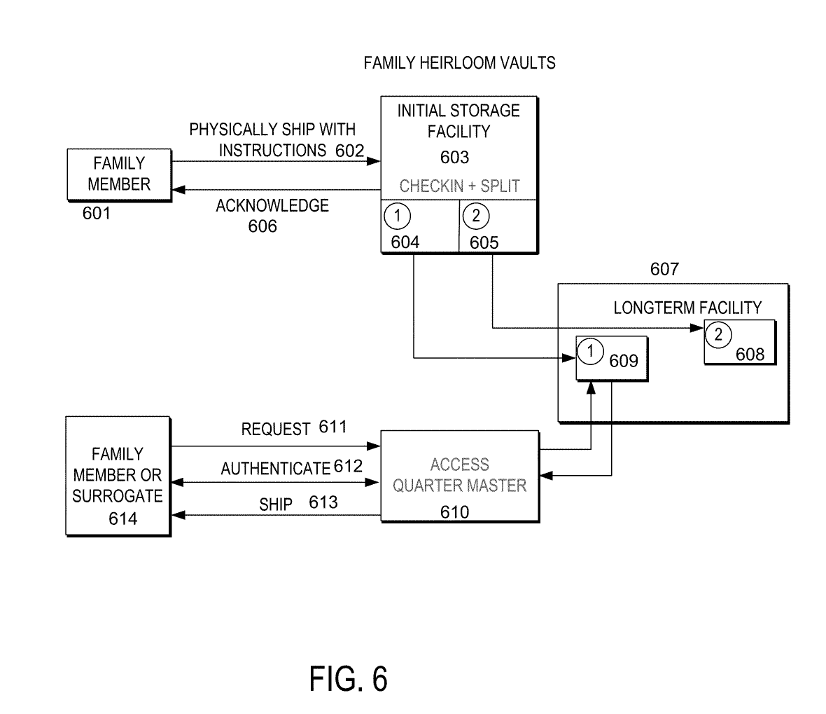

Referring now to FIG. 6, a block diagram illustrates embodiments of the present invention that include storage of physical Family Heirlooms. As illustrated, according to some embodiments of the present disclosure, a Family Member, such as one designated as an Access Quarter Master 610, may physically ship a Family Heirloom that includes a document or an artifact to an initial storage facility 603 for retention in a Family Vault. The storage facility 603 may check in a received Family Heirloom. In some instances, the initial storage facility may also split the contents of a received package and store the contents in separate storage entries, such as a first storage entry 604 and a second storage entry 605. The initial storage facility 603 may also generate and send an acknowledgement of receipt of the Family Heirlooms. The acknowledgement may include, for example, identifiers for the entries 604 and 605.

In some embodiments, a long term facility 607 may be utilized to further catalogue and store documents and artifacts shipped to be included in a Family Vault Storage. The long term Storage facility 607 may be akin to a safe deposit box, except that a virtual index of contents may be made to Family Members and Surrogates. In addition, in some embodiments, an Access Quarter Master 610 may control access to stored physical documents and artifacts. An Access Quarter Master 610 may include a human being or an automated apparatus for receiving and processing requests for access to a stored physical document or artifact.

In some embodiments of the present disclosure, an Access Quarter Master 610 may receive a request 611 from a Family Member or Surrogate 614. The request may be processed by an Access Quarter Master 610 to determine if the Family Member or Surrogate 614 has proper authorization to access a requested physical document or artifact. In addition, an Access Quarter Master 610 may authenticate a request to determine that the requesting Family Member or Surrogate 614 is who they claim to be. If the Access Quarter Master determines that the request is from a legitimate and authorized Family Member or Surrogate 614, then the Access Quarter master may have the requested document or artifact delivered.

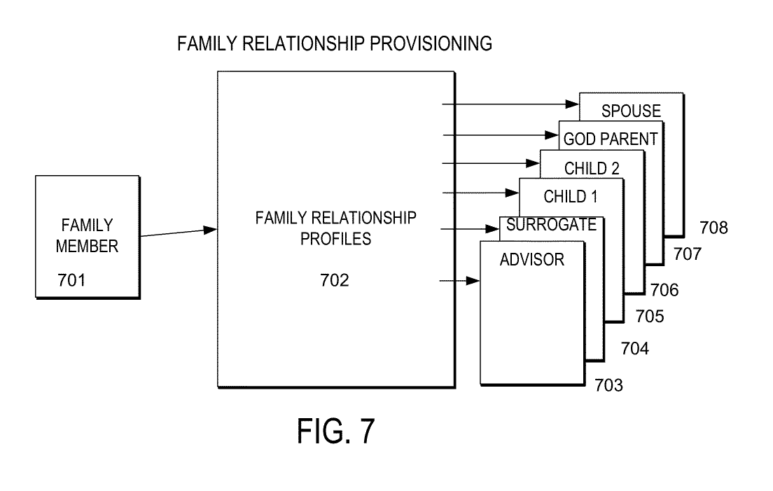

Referring now to FIG. 7, in another aspect of the present invention, a Family member 701 may provision various familial relationships in an automated Family Relationship Profiles Device 702 system that includes a processor and code. The Family Relationship Profiles Device may receive instructions in the form of digital messages that define a relationship with one or more other Family Members and Surrogates 703-708. More specifically, the Family Relationship Profile apparatus 702 may receive an instruction that defines a relationship between a Family Member and one or more or: an advisor 703, a surrogate 704, a first child 705, another second child 76, a God Parent 707 and a spouse 708.

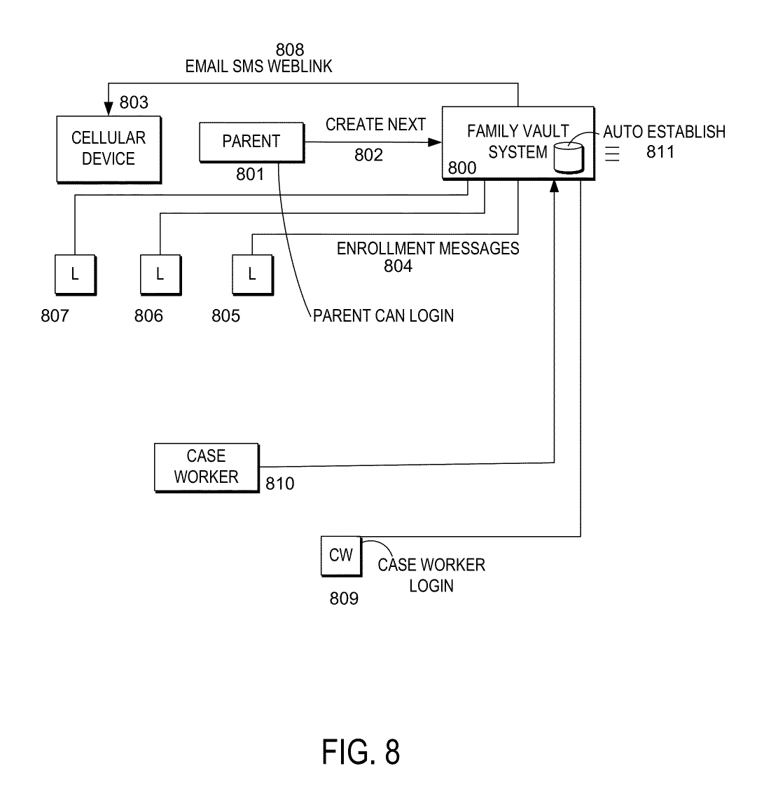

Referring now to FIG. 8, a block diagram illustrates aspects of the present disclosure that allow for a parent 801 to create a next family member relationship 802 and thereby link in another Family Member to the Family Vault System 800. In some embodiments the creation of a new family relationship may be followed by an SMS message 808 to a cellular device 803. The message may confirm the creation of a new relationship and also act as a safety to prevent unauthorized entries of new family members.

The Family Vault System 800 may also forward enrollment messages 804 to Family members 805-807. In another aspect the Family Vault System 800 may also process and admit a Case Worker 808 as an authorized person to access records in a Family Vault 800. The caseworker may be verified via a case worker login routine 809.

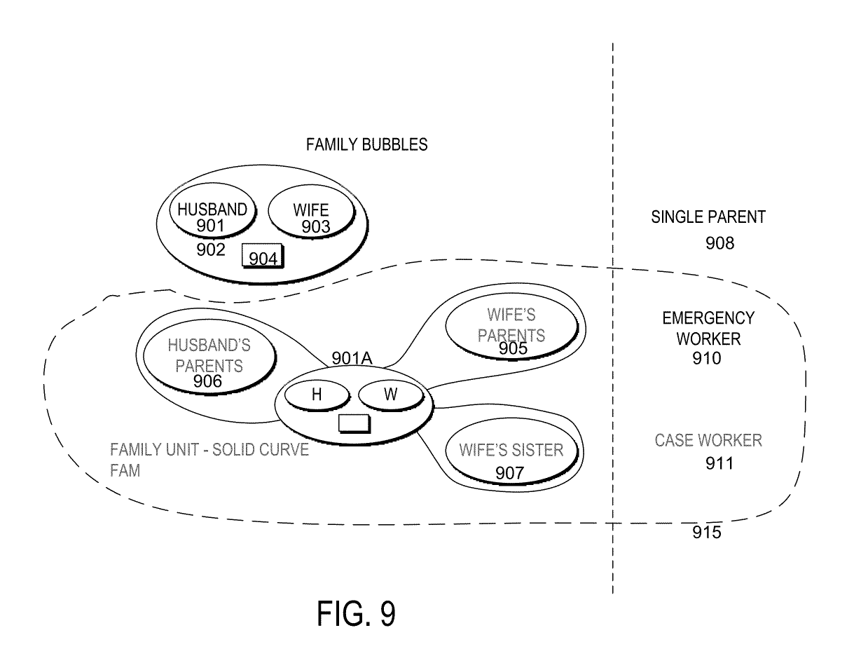

Referring now to FIG. 9, a Venn type diagram illustrates “Family Bubbles” to represent various familial relationships. The diagram is for illustrative purposes of some examples and is not meant to limit the scope of the invention. As illustrated, some examples of a family 901 may include a husband 902 and a wife 903 and a child 904. Other embodiments may include a family 901A that additionally include a husband's parents 906 and a wife's parents 905 and a Wife's sister or other traditional relationship such as, for example a relationship defined by one or both of a genetic link or legal association.

By way of non-limiting example, a legal association may include an emergency worker 910, a case worker 911, a guardianship, a foster parent, an adopted parent or other relationship according to a sanctioned authority. Still other embodiments may include a single parent 908 and one or more children.

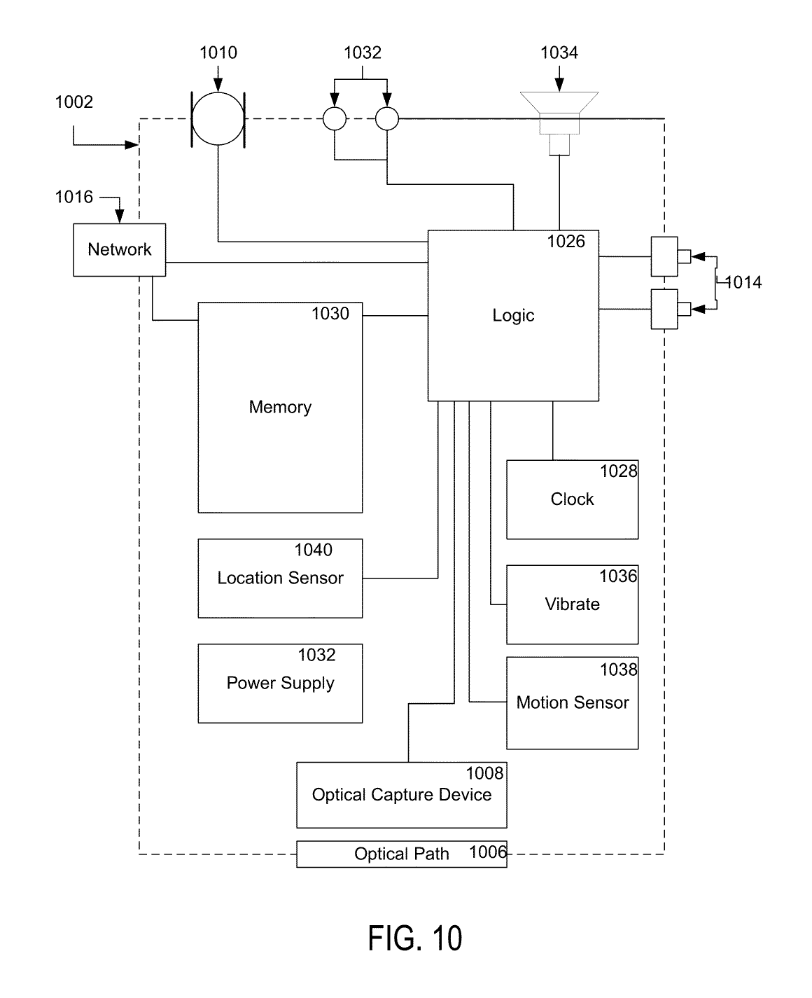

FIG. 10 is a block diagram of some embodiments of a network access device that may include a mobile device 1002. The network access device may be used to access a Family Vault as discussed above. Access may, for example, include one or both of retrieval of stored documents and submission of documents into a Family Vault. Accordingly, a network access device may include a mobile device 1002 with a display capable of displaying a human readable graphical user interface and an optical capture device 1008 to capture an image and convert it to machine-compatible data for submission of the image data into a Family Vault. An image may be captured via an optical path 1006, typically a lens, an aperture or an image conduit to convey the image from the rendered document to the optical capture device 1008. The optical capture device 1008 may incorporate a Charge-Coupled Device (CCD), a Complementary Metal Oxide Semiconductor (CMOS) imaging device, or an optical sensor of another type.

A microphone 1010 and associated circuitry may convert associated sound of an environment, including spoken words, into machine-compatible signals. Input facilities 1014 exist in the form of buttons, scroll-wheels or other tactile sensors such as touch-pads. In some embodiments, input facilities 1014 may include a touchscreen display. Image data and audio data may be transmitted to a Family Vault.

Visual feedback to the user is possible through a visual display, touchscreen display, or indicator lights. Audible feedback 1034 may come from a loudspeaker or other audio transducer. Tactile feedback may come from a vibrate module 1036.

A motion sensor 1038 and associated circuitry convert the motion of the mobile device 1002 into machine-compatible signals. The motion sensor 1038 may comprise an accelerometer which may be used to sense measurable physical acceleration, orientation, vibration, and other movements. In some embodiments the motion sensor 1038 may include a gyroscope or other device to sense different motions.

A location sensor 1040 and associated circuitry may be used to determine the location of the device. The location sensor 1040 may detect Global Position System (GPS) radio signals from satellites or may also use assisted GPS where the mobile device may use a cellular network to decrease the time necessary to determine location. In some embodiments, the location sensor 1040 may use radio waves to determine the distance from known radio sources such as cellular towers to determine the location of the mobile device 1002. In some embodiments these radio signals may be used in addition to GPS.

The mobile device 1002 comprises logic 1026 to interact with the various other components, possibly processing the received signals into different formats and/or interpretations. Logic 1026 may be operable to read and write data and program instructions stored in associated storage 1030 such as RAM, ROM, flash, or other suitable memory. It may read a time signal from the clock unit 1028. In some embodiments, the mobile device 1002 may have an on-board power supply 1032. In other embodiments, the mobile device 1002 may be powered from a tethered connection to another device, such as a Universal Serial Bus (USB) connection.

The mobile device 1002 also includes a network interface 1016 to communicate data to a network and/or an associated computing device. Network interface 1016 may provide two-way data communication. For example, network interface 1016 may operate according to the internet protocol. As another example, network interface 1016 may be a local area network (LAN) card allowing a data communication connection to a compatible LAN. As another example, network interface 1016 may be a cellular antennae and associated circuitry which may allow the mobile device to communicate over standard wireless data communication networks. In some implementations, network interface 1016 may include a Universal Serial Bus (USB) to supply power or transmit data. In some embodiments other wireless links may also be implemented.

As an example of one use of mobile device 1002, a reader may scan some text from a newspaper article with mobile device 1002. The text is scanned as a bit-mapped image via the optical capture device 1008. Logic 1026 causes the bit-mapped image to be stored in memory 1030 with an associated time-stamp read from the clock unit 1028. Logic 1026 may also perform optical character recognition (OCR) or other post-scan processing on the bit-mapped image to convert it to text. Logic 1026 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 1026) to an associated computer via network interface 1016.

As an example of another use of mobile device 1002, a reader may capture some text from an article as an audio file by using microphone 1010 as an acoustic capture port. Logic 1026 causes audio file to be stored in memory 1028. Logic 1026 may also perform voice recognition or other post-scan processing on the audio file to convert it to text. As above, the reader may then upload the audio file (or text produced by post-scan processing performed by logic 1026) to an associated computer via network interface 1016.

The present invention is described herein with reference to block diagrams and functional illustrations of methods and apparatus to implement various aspects of the present invention. It is understood that each block of the block diagrams or operational illustration or function represented, and combinations of blocks in the block diagrams or operational or functional illustrations, may be implemented by automated apparatus, such as analog or digital hardware and computer program instructions. These computer program instructions may be provided to a processor of a general purpose computer, special purpose computer, cellular device, smart device, ASIC, or other programmable data processing apparatus, such that the instructions, which execute via the processor of the computer or other programmable data processing apparatus, implements the functions/acts specified in the block diagrams or operational block or blocks. In some implementations, the functions or method steps described in relation to the blocks or functional representations may occur in an order other than the order noted or described herein, For example, blocks or functional representations shown in a succession may be executed substantially concurrently or the blocks in an alternate order, depending upon a specific implementation of the present invention. It is therefore understood that unless otherwise specifically noted and thereby limited, the discussion here is presented in an order to facilitate enablement and understanding and is not meant to limit the invention disclosed.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

What is claimed is:

1. A method for securely storing and accessing Family Docs associated with a Family, the method comprising:
closing a first switch to supply electrical energy to a computer server accessible with a network access device via a communications network; and
closing a second switch to execute software stored on the server and executable upon demand, the software operative with the server to cause the computer server to:
establish a Unique Identifier for a first Family Member and a second Family Member;
designate an authority sanctioned relationship between the first Family Member and the second Family Member;
create a Family Storage Vault mechanism specific to the family based upon the first Family Member and the second Family Member and capable of storing digital documents or artifacts;
provide administrator rights to the first Family Member for the family storage mechanism, wherein administrator rights comprise the ability to assign access rights to the family storage vault mechanism for other users;
provide access rights to the second Family Member, wherein access rights allow for submission of one or both of documents and artifacts for storage in the family storage vault;
receive one or more Family Docs associated with the family;
store the Family Docs associated with the family in the family storage vault mechanism; and
limit access to the stored documents based at least in part according to a status as a first Family Member or a second Family Member.

2. The method of claim 1 wherein the access rights for the second Family Member additionally comprise authorization to access documents and artifacts stored in the family storage vault;

3. The method of claim 1 wherein the software is additionally operative to:
receive an instruction to designate a third Family Member in an additional government authorized relationship to the second Family Member; and
provide administrator rights to the third Family Member.

4. The method of claim 1 wherein the software is additionally operative to:
receive an instruction to designate a third Family Member as a proxy for the first Family Member; and
provide administrator rights to the proxy for the first Family Member.

5. The method of claim 1 wherein the software is additionally operative to:
receive an instruction to designate a non-Family Member as a proxy for the first Family Member; and
provide administrator rights to the designated non-Family Member.

6. The method of claim 1 wherein the software is additionally operative to:
receive a document from an outside submitting agent that is not designated as a Family Member;
associate one or both of the first Family member and the second Family Member with the received document; and
storing the document received from the outside submitting agent in a Family Storage Vault allocated to the Family Member.

7. The method of claim 1 wherein the software is additionally operative to:
define a third Family Member; and
designate a hierarchical relationship between one or both of the first Family Member and the second Family Member and the third Family Member.

8. The method of claim 1 wherein the software is additionally operative to:
receive an authentication related to a document or artifact submitted to a Family Storage Vault;
store the related document or artifact in a specific storage mechanism based upon the authentication.

9. The method of claim 1 wherein the software is additionally operative to:
receive a digital document from a government authorized entity;
associate the digital document with one of the first Family Member and the Second Family Member; and
store the received digital document in a Family Storage Vault associated with the associated first Family Member or the second Family Member.

10. The method of claim 1 wherein the software is additionally operative to:
generate a Family Storage Vault account associated with a third person;
allocate storage parameters for the third person Family Storage Vault account comprising security rights for the third person and a fourth person;
generate a government defined relationship between the third person and one or both of the first person and the second person; and
automatically generate access rights for the third person to the Family Storage Vault mechanism specific to the family based upon the first Family Member and the second Family Member.

11. The method of claim 1 wherein the software is additionally operative to:
generate a list comprising a potential third party submitter of information and associate a storage designation for associated with the potential third party submitter;
receive a communication from a sender comprising the third party submitter, the communication comprising information to be stored in the Family Storage Vault;
analyze the communication to determine an identifier associated with the sender; and
store the information to be stored in the Family Storage Vault in the storage designation associated with the potential third party submitter.

12. The method of claim 1 wherein the identifier associated with a sender comprises a sender's name.

13. The method of claim 1 wherein the identifier associated with a sender comprises a domain name associated with an origination of the communication.

14. The method of claim 1 wherein the identifier associated with a sender comprises a sender's email account.

15. The method of claim 1 wherein the software is additionally operative to:
receive an identification of a third Family Member wherein the third Family Member has a legal guardian;
receive authorization from the legal guardian to store documents associated with the third Family Member in the Family Storage Vault;
receive a document associated with the third Family Member;
allocate a storage destination for the document associated with the third Family Member; and
store the document in the storage destination.

16. The method of claim 1 wherein the software is additionally operative to:
generate a list of Family Member identifiers;
make the list of Family Member identifiers available to legal authorities across multiple legal jurisdictions;
receive a communication comprising a Family Member identifier from an originator authorized by at least one legal authority; and
store the communication in a destination associated with the Family Member associated with the Family Member identifier.

17. The method of claim 16 wherein the software is additionally operative to:
generate a new storage destination based upon the originator and store the communication in the new destination.

18. The method of claim 16 wherein the software is additionally operative to:
receive one or more documents and artifacts with the communication and additionally store the documents and artifacts in a storage destination associated with the Family Member identifier.

19. The method of claim 1 wherein the software is additionally operative to:
receive an identification of an email account associated with a Family Member;
receive a communication from the email account associated with a Family Member; and
identify multiple family storage vaults associated with the email account; and
store a document included in the communication in more than one of the multiple family storage vaults associated with the email account.

20. The method of claim 1 wherein the software is additionally operative to:
receive a communication from a third Family Member, wherein the communication comprises identification of persons associated with the third Family Member;
associate an identification of persons associated with the third Family Member with one or both of the first Family Member and the second Family Member; and
send a notification to one or both of the first Family Member and the second Family Member wherein the notification comprises a description of the third Family Member and a possible relationship between the third Family Member and one or both of the first Family Member and the second Family Member.
